(19) United States
(12) Patent Application Publication
(10) Pub. No.: US 2007/0136129 A1
(43) Pub. Date: Jun. 14, 2007

(54) Customer data collection system

(75) Inventors: John C. Handley, Fairport, NY (US); Timothy W. Jacobs, Fairport, NY (US)

Correspondence Address: PEPPER HAMILTON LLP, ONE MELLON CENTER, 50TH FLOOR, 500 GRANT STREET, PITTSBURGH, PA, 15219, US

(73) Assignee: Xerox Corporation

(21) Appl. No.: 11/301,536

(22) Filed: Dec. 13, 2005

(51) Int. Cl. G06Q 30/00

(52) U.S. Cl. 705/14

(57) ABSTRACT

A method includes identifying a usage fee and a monitoring fee for a user of a multifunction system over a time period. The monitoring fee entitles the user to receive monitoring of one or more usage data points on the multifunction system over the time period. Each usage data points corresponds to a level of use of a function of the multifunction system. If the monitored usage data point satisfies an incentive criterion, the user may be provided with a financial incentive, such as a rebate, discount or credit of a portion of the usage fee.

### BACKGROUND

1. Technical Field

The disclosed embodiments generally relate to methods and systems for collecting usage data for multifunction devices.

2. Description of the Related Art

Multifunction devices are increasingly common in office environments, manufacturing environments, other commercial environments and residential environments. For example, in an office environment, a multifunction printing device may perform some or all of the following functions: black-and-white printing, color printing, single-sided printing, double-sided printing, photocopying, faxing, e-mailing, scanning, or one or more finishing functions such as stapling, collating, punching, binding or other features. Other multifunction devices exist in other fields, such as the food preparation industry, dry cleaning industry, hospitals and other fields.

In addition, many workflows are implemented through multi-device systems. For example, a print shop may include one or more high speed printers or presses; finishing devices such as perforating machines, folders, binders and cornering machines, and padding presses; and packaging machines such as inserting systems and labeling devices.

Methods and systems for gathering data relating to the usage of various functions of multifunction devices and multi-device systems are also known. For example, U.S. Pat. No. 6,959,442, the disclosure of which is incorporated herein by reference in its entirety, describes a computer program, operable on at least one computer, for accessing machine software operative of a machine such as a digital copier. In U.S. Pat. No. 6,959,442, the system remotely gathers data from one or more ports of the machine.

Although methods and systems for gathering data from remote devices exist, many users of multifunction systems and multi-device systems are reluctant or unwilling to permit remote access to machine data. In addition, multifunction and multi-device system users generally receive no direct benefit for permitting remote monitoring of their devices. The present disclosure describes attempts to solve one or more of these problems.

### SUMMARY

In an embodiment, a method of charging a user of a first multifunction system may include identifying a first fee, or a user fee, and monitoring a plurality of usage data points of the first multifunction system over a time period. Each usage data point corresponds to a function of the first multifunction system. For example, where the system is a printing system, the functions may include black-and-white copying, color copying, single-sided copying, two-sided copying, faxing, e-mailing, scanning, collating, stapling, hole punching and/or binding. The method may also include determining whether at least one of the monitored usage data points satisfies an incentive criterion. If at least one of the monitored usage data points satisfies the incentive criterion, the method may include providing a financial incentive to the user. A usage data point may include a measurement of use of a function of the first multifunction system, and the incentive criterion may be a maximum level of use of the function in the time period. The usage data point may satisfy the incentive criterion if the usage data point has a value that does not exceed the maximum level of use of the function in the time period. Alternatively, the incentive criterion may be a minimum level, and the usage data point may satisfy the incentive criterion if the usage data point has a value that does not go below the minimum level in the time period. Optionally, the method may also include adjusting the incentive criterion based on benchmarking data received from other users of other multifunction systems.

Optionally, the incentive may include a discount to the user fee, a rebate of a portion of the user fee, or a credit against a future fee. In some embodiments, the user fee may relate to usage or maintenance of the first multifunction system, the user may be charged a second fee, or monitoring fee, for the monitoring, and the financial incentive may have a financial value that exceeds that of the monitoring fee.

In various embodiments, the method may also include providing the user a report of the monitored usage data points. The report may include a comparison of the monitored usage data points to one or more benchmark values. It may also include an analysis of one or more monitored data point trends over a plurality of time periods. In various embodiments, the method may also include monitoring usage data points for a second multifunction system over the time period, wherein each usage data point for the second multifunction system corresponds to a function of the second multifunction system. In such embodiments, the report may also include a comparison of the monitored usage data points for the second multifunction system to the one or more benchmark values, and the report may also include a comparison of the monitored usage data points for the first multifunction system to the monitored usage data points for the second multifunction system.

In an alternate embodiment, a method of promoting a monitoring service includes charging a user of a first multifunction system a user fee, charging the user a monitoring fee, monitoring a usage level of a function of the first system over a time period, and determining whether the usage level satisfies an incentive criterion. If the usage level satisfies the incentive criterion, the method may also include providing a financial incentive to the user as a discount or rebate of, or credit toward, at least a portion of the user fee, wherein the financial inventive has a value that equals or exceeds the monitoring fee for the time period. The method may also include providing the user a report of the monitored usage level, wherein the report includes a comparison of the monitored usage level to a benchmark value. The method may also include monitoring a usage level for the same or a different function on a second multifunction system over the time period, and the report may include a comparison of the monitored usage level for the second multifunction system to the one or more benchmark values, as well as a comparison of the monitored usage level for the first multifunction system to the monitored usage level for the second multifunction system. The method may also include adjusting the incentive criterion based on benchmarking data received from a multiple users of multifunction systems.

In an alternate embodiment, a method may include identifying a usage fee for a user of a multifunction system over a time period, identifying a monitoring fee for the user over the time period, and monitoring a usage data point of the multifunction system over the time period, wherein the usage data point corresponds to a level of use of a function of the multifunction system. The method may also include determining whether the monitored usage data point satisfies an incentive criterion, such as a maximum or minimum level of use of the function. If the monitored usage data point satisfies the incentive criterion, the method may include providing a financial incentive to the user, wherein the financial incentive has a value that exceeds the monitoring fee. The method may also include providing the user a report comprising the monitored usage data point, wherein the report includes a comparison of the monitored usage data point to one or more benchmark values.

In an alternate embodiment, a system may include a billing module that identifies a user fee and a monitoring fee to be billed to a user of a multifunction system. The system may also include a monitoring module that receives output from a monitoring device, wherein the monitoring device obtains usage data for a function of the multifunction system. The system may also include an incentive module that determines whether the usage data satisfies an incentive criterion and instructs a module to provide the user with a financial incentive if the usage data satisfies the incentive criterion. The system may include, for example, a multifunction printing device or a multi-device print shop.

### BRIEF DESCRIPTION OF THE DRAWINGS

FIG. 1 is a process diagram illustrating an exemplary data collection process.

FIG. 2 is a block diagram illustrating exemplary features of a data collection system.

### DETAILED DESCRIPTION

Before the present methods, systems and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope.

It must also be noted that as used herein and in the appended claims, the singular forms “a,” “an, ” and “the” include plural references unless the context clearly dictates otherwise. Unless defined otherwise, all technical and scientific terms used herein have the same meanings as commonly understood by one of ordinary skill in the art. Although any methods, materials, and devices similar or equivalent to those described herein can be used in the practice or testing of embodiments of the invention, the preferred methods, materials, and devices are now described. All publications mentioned herein are incorporated by reference. Nothing herein is to be construed as an admission that the invention is not entitled to antedate such disclosure by virtue of prior invention.

A multifunction system is any device or group of devices having multiple functional features that are interconnected to allow a user to complete multiple tasks and/or one or more multifunction tasks. For example, in an office environment or print shop, a multifunction printing system may include one or more interconnected machines that perform some or all of the following functions: black-and-white printing, color printing, single-sided printing, double-sided printing, photocopying, faxing, e-mailing, scanning, or one or more finishing functions such as stapling, collating, punching, binding or other features. The user may select one or more of these functions, such as faxing, as a single task. In addition, the user may select a group of functions, such as black-and-white printing, color printing, collating and binding, to accomplish the task of printing and binding multiple copies of a multi-page document. Alternatively, a multifunction system may include a single device that performs multiple functions, such as a digital production press that prints color and/or black-and-white copies on various paper formats and that also has in-line finishing capabilities such as booklet-making, hole punching, and binding. Other examples include digital copier-printers such as those described in U.S. Pat. No. 6,844,937, the disclosure of which is incorporated herein by reference in its entirety.

In an embodiment, a entity that makes, sells, distributes or services a multifunction system may charge the device's user in whole or in part based on that customer's usage of one or more functions of the system. For example, in the case of a multifunction printing system, the entity may charge the user a fee based on the number of “clicks,” or instances of usage, of a function. An example may be a per-page printing fee, which may vary based on function (e.g., a lower price for a single-sided black-and-white page, and a higher charge for a double-sided or color page). Such use-based charges may apply in any or all of various circumstances, such as: (i) use-based fees may be applied in lieu of a purchase price on the customer for the device; (ii) use-based fees may be applied in lieu of a portion of an up-front device delivery or purchase fee; and/or (iii) use-based fees may be applied to cover some or all of a service, materials supply or maintenance contract.

Alternatively, the user may be charged a fixed fee, such as a flat monthly service fee, covering all of the customer's usage of all functions within the billing period. Optionally, the a base fee may be applied in a time period, with additional charges accruing if a customer's usage of one or more functions exceeds a predetermined level. For example, a customer may be charged a flat monthly fee of $ 100.00 if the customer prints up to 10,000 pages on the device in a month. However, if the customer's printing exceeds 10,000 pages in a given month, the customer may be assessed extra usage charges in that month.

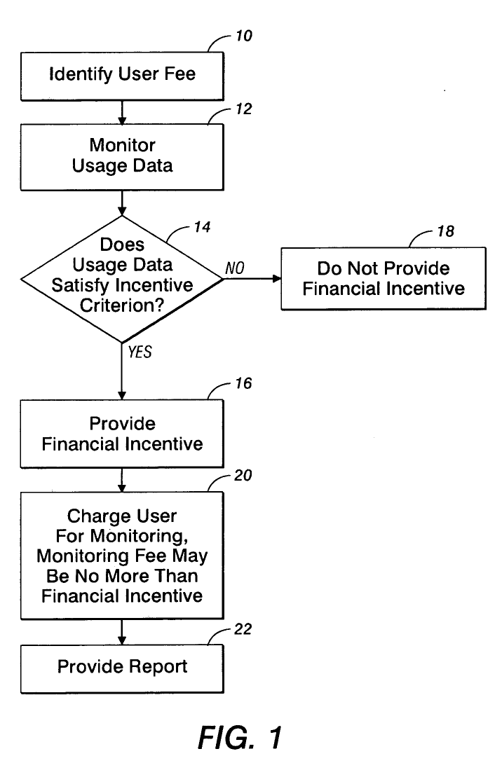

Referring to FIG. 1, in an embodiment a user fee may be identified 10 for a user of a multifunction system. The user fee may be a fixed fee for a time period, a base fee for a time period, and/or a “per-click” fee based on actual usage of one or more functions. In addition or alternatively, the user fee may be based on actual or expected maintenance service to be provided in a time period.

The multifunction device may include software and/or hardware for monitoring 12 usage data points for one or more functions. For example, a multifunction printing system may include a counter for determining a number of black-and-white prints or copies made, color prints or copies made, single-sided prints or copies made, double-sided prints or copies made, photocopying, fax pages sent, e-mails sent, pages or documents scanned, staples used, or documents collated, punched or bound in a given time period. The monitored usage data points may be collected locally by a device, such as a computing device, that is electronically connected to the multifunction system. Alternatively or in addition, the monitoring may be performed remotely, via a communication network through a modem, Internet connection, intranet connection, telephone, or other network, with the usage data collected at a remote location by a remote computing device. Monitoring may include active monitoring (i.e., where data is delivered to a collection system on a regular or near-continuous basis), or it may include periodic monitoring (i.e., where data is delivered to a collection system on a periodic basis), or it may include passive monitoring (i.e., where data is delivered to a collection system only upon issuance of a delivery command).

In an embodiment, the local computing device, remote computing device, or another device that receives the usage data may determine 14 whether at least one of the monitored usage data points satisfies an incentive criterion. The incentive criterion may be, for example, a maximum level of use of the function in the time period, and the usage data point may satisfy the incentive criterion if the usage data point has a value that does not exceed the maximum level of use of the function in the time period. Alternatively, the incentive criterion may be a minimum level of use of the function in the time period, and the usage data point may satisfy the incentive criterion if the usage data point has a value that equals or exceeds the minimum level of use of the function in the time period.

If at least one of the monitored usage data points satisfies the incentive criterion, a financial incentive 16 may be provided to the user of the monitored multifunction system. If none of the monitored usage data points satisfies the incentive criterion, then no financial incentive 18 may be provided to the user for the monitored system.

For example, in an embodiment where the user fee comprises a monthly usage and/or maintenance fee for a multifunction printer, the monitoring system may monitor a copy counter over a billing cycle. The incentive criterion may comprise a predetermined maximum number of copies to be made by the printer in the billing cycle. If the monitoring system determines that the printer did not exceed the maximum number of copies in the billing cycle, then the system may provide, or it may alert another system to provide, the printer's user with a financial incentive such as a discount to the monthly fee, a rebate of a portion of the monthly fee, and/or a credit against a future fee. Although not required, in various embodiments, the financial incentive available for a time period may not exceed the user fee for the time period. Also optionally, the incentive criterion may be “stepped” or “graduated” such that various minimum or maximum user amounts will result in different incentive amounts.

Optionally, the user may be charged a monitoring fee 20 for the monitoring service. However, although also optional, in various embodiments the financial incentive provided for a billing cycle or other time period will equal or exceed the monitoring fee corresponding to the time period.

In various embodiments, a user who accepts a monitoring service may receive a report 22 of device usage during a monitoring period. The report may be delivered electronically, in hard copy, or by one or more other methods. The report may include, for example a comparison of the monitored usage data points to one or more benchmark values. The benchmark values may include, for example, average measured user data, usage levels for which a device is designed to operate at maximum energy or wear efficiency, or other benchmarking data. Benchmark values may be predetermined or stored in a memory, or they may vary and change “on the fly” as user data is collected from multiple users of similar devices. The report may also show trends in usage data over one or more time periods, such as month-to-month variations, day-to-day variations, or other trends.

In addition, benchmarking data collected from multiple users of multiple systems may be used to adjust the incentive criteria. For example, if data shows that over time, the average user's number of pages printed by a multifunction printers increases by ten percent per month, then an incentive criterion corresponding to monthly print counts may also be adjusted upward by ten percent or another appropriate amount. Alternatively or in addition, incentive criteria may be adjusted based on manually input data or other factors.

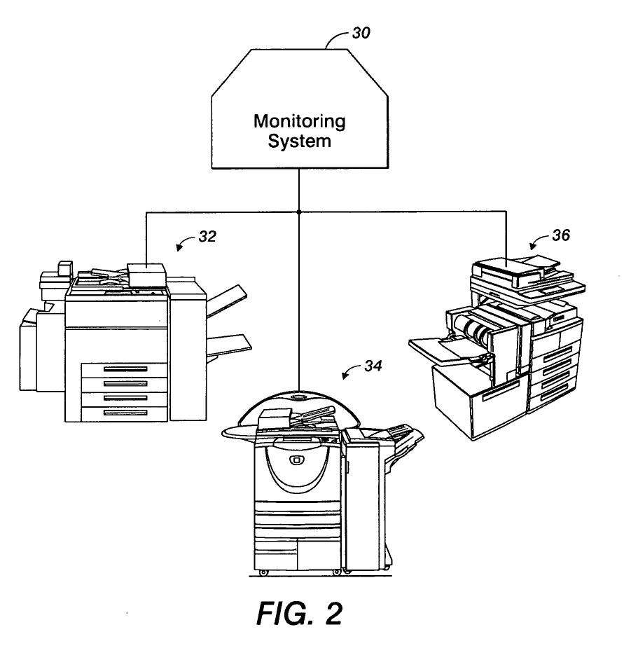

In addition, referring to FIG. 2, a monitoring system 30 may monitor usage data of multiple multifunction systems in a work environment or other location. For example, a business having multiple multifunction printing devices 32, 34, 36 may monitor data points for each device, and it may receive incentives and/or reports corresponding to some or all of the devices. In such systems, the usage fees and incentives may be applied on a per-device basis or a system-wide basis in various embodiments.

Reports such as those described herein may, in various embodiments, optionally help users assess which devices on a system are overutilized, which devices are underutilized, which devices are subject to suspicious activity (such as extreme off-hours usage), which hours and/or days result in higher usage, which devices have higher usage of a particular function, or other system aspects. This may help a system user determine whether additional devices may be needed, whether fewer devices may be sufficient, whether multifunction systems are optimally positioned in a work environment, or other aspects than may help to improve efficiency.

Systems such as those used herein may be used to reward customers who accept monitoring services, to help customers improve the efficiency of multifunction device usage, and/or to help multifunction device suppliers gather and assess benchmarking data of device usage. Other uses and applications are also possible.

An embedded system may optionally be used to perform one, some or all of the operations of the methods described. Likewise, a multiprocessor system may optionally be used to perform one, some or all of the methods described. For example, a system may include software on one or more devices, and the software may include various modules containing instructions that implement some or all of the methods described herein. A module may include a separate program or a portion of code within a larger program. For example, the monitoring system 30 of FIG. 2 may include a computer system with one or more devices having software that includes a billing module, a monitoring module, an incentive module. The billing module may identify and/or bill the user a user fee for usage of a multifunction system. The billing module or another module may also bill the user a monitoring fee for a monitoring service. The monitoring module may receive output from one or more monitoring devices, such as counters or clock devices, in the multifunction system so that the monitoring system receives usage data relating to various functions of the multifunction system. The incentive module may determine whether the usage data satisfies one or more incentive criteria, and it may instruct the billing module or another module to provide the user with a financial incentive if the usage data satisfies appropriate incentive criteria.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of charging a user of a multifunction system, comprising:
identifying a first fee for a user of a first multifunction system;
monitoring a plurality of usage data points of the first multifunction system over a time period, wherein each usage data point corresponds to a function of the first multifunction system;
determining whether at least one of the monitored usage data points satisfies an incentive criterion; and
if at least one of the monitored usage data points satisfies the incentive criterion, providing a financial incentive to the user.

2. The method of claim 1, wherein the incentive comprises a discount to the first fee, a rebate of a portion of the first fee, or a credit against a future fee.

3. The method of claim 2, wherein:
the first fee comprises a fee for usage or maintenance of the first multi function system;
the financial incentive has a financial value that exceeds a financial value of a second fee;
the second fee comprises a fee for the monitoring; and
the first fee exceeds the second fee.

4. The method of claim 1, further comprising:
providing the user a report of the monitored usage data points, wherein the report includes a comparison of the monitored usage data points to one or more benchmark values.

5. The method of claim 4, further comprising:
monitoring a plurality of usage data points for a second multifunction system over the time period, wherein each usage data point for the second multifunction system corresponds to a function of the second multifunction system; and
wherein the report also includes a comparison of the monitored usage data points for the second multifunction system to the one or more benchmark values; and
wherein the report also includes a comparison of the monitored usage data points for the first multifunction system to the monitored usage data points for the second multifunction system.

6. The method of claim 4, wherein the report also includes an analysis of one or more monitored data point trends over a plurality of time periods.

7. The method of claim 1, wherein:
the first fee comprises a fee for usage or maintenance of the first multifunction system;
a usage data point comprises a measurement of use of a function of the first multifunction system;
the incentive criterion comprises a maximum level of use of the function in the time period; and
the usage data point satisfies the incentive criterion if the usage data point has a value that does not exceed the maximum level of use of the function in the time period.

8. The method of claim 7, wherein:
the first fee comprises a fee for usage or maintenance of the first multifunction system;
the incentive comprises a discount to the first fee, a rebate of a portion of the first fee, or a credit against a future fee;
the financial incentive has a financial value that exceeds a financial value of a second fee;
the second fee comprises a fee for the monitoring; and
the first fee exceeds the second fee.

9. The method of claim 1, wherein:
the first multifunction system comprises a multifunction printing system;
the function comprises black-and-white copying, color copying, single-sided copying, two-sided copying, faxing, e-mailing, scanning, collating, stapling, hole punching or binding; and
wherein the determining comprises determining whether a monitored usage data point for the function has a value that does not exceed a maximum usage level for the function over the time period.

10. The method of claim 1, wherein:
the first multifunction system comprises a multifunction printing system;
the function comprises black-and-white copying, color copying, single-sided copying, two-sided copying, faxing, e-mailing, scanning, collating, stapling, hole punching or binding; and
wherein the determining comprises determining whether a monitored usage data point for the function has a value that exceeds a minimum usage level for the function over the time period.

11. The method of claim 1, further comprising:
adjusting the incentive criterion based on benchmarking data received from a plurality of users of a plurality of multifunction systems.

12. A method of promoting a monitoring service, comprising:
charging a user of a first multifunction system a user fee;
charging the user a monitoring fee;
monitoring a usage level of a function of the first system over a time period;
determining whether the usage level satisfies an incentive criterion; and
if the usage level satisfies the incentive criterion, providing a financial incentive to the user as a discount or rebate of, or credit toward, at least a portion of the user fee, wherein the financial inventive has a value that equals or exceeds the monitoring fee for the time period.

13. The method of claim 12, further comprising:
providing the user a report of the monitored usage level, wherein the report includes a comparison of the monitored usage level to a benchmark value.

14. The method of claim 13, further comprising:
monitoring a usage level for a function on a second multifunction system over the time period;
wherein the report includes a comparison of the monitored usage level for the second multifunction system to the one or more benchmark values; and
wherein the report also includes a comparison of the monitored usage level for the first multifunction system to the monitored usage level for the second multifunction system.

15. The method of claim 12, further comprising:
adjusting the incentive criterion based on benchmarking data received from a plurality of users of a plurality of multifunction systems.

16. A method, comprising:
identifying a usage fee for a user of a multifunction system over a time period;
identifying a monitoring fee for the user over the time period;
monitoring a usage data point of the multifunction system over the time period, wherein the usage data point corresponds to a level of use of a function of the multifunction system;
determining whether the monitored usage data point satisfies an incentive criterion; and
if the monitored usage data point satisfies the incentive criterion, providing a financial incentive to the user, wherein the financial incentive has a value that exceeds the monitoring fee.

17. The method of claim 16, further comprising:
providing the user a report comprising the monitored usage data point, wherein the report includes a comparison of the monitored usage data point to one or more benchmark values.

18. The method of claim 16, wherein the incentive criterion comprises a maximum or minimum level of use of the function.

19. The method of claim 16, wherein:
the first multifunction system comprises a multifunction printing system; and the function comprises black-and-white copying, color copying, single-sided copying, two-sided copying, faxing, e-mailing, scanning, collating, stapling, hole punching or binding.

20. A system, comprising:
a billing module that identifies a user fee and a monitoring fee to be billed to a user of a multifunction system;
a monitoring module that receives output from a monitoring device, wherein the monitoring device obtains usage data for a function of the multifunction system; and
an incentive module that determines whether the usage data satisfies an incentive criterion and instructs a module to provide the user with a financial incentive if the usage data satisfies the incentive criterion.

21. The system of claim 20, wherein the multifunction system comprises a multifunction printing device or a multi-device print shop.
